(19) United States
(12) Patent Application Publication
(10) Pub. No.: US 2026/0245483 A1
(43) Pub. Date: Aug. 20, 2026

(54) IDENTIFICATION TAG APPARATUS USING MAGNETIC MATERIAL

(71) Applicant: Darcy James Pritchard, St. Andrews (CA)

(72) Inventor: Darcy James Pritchard, St. Andrews (CA)

(21) Appl. No.: 19/538,375

(22) Filed: Feb. 12, 2026

Related U.S. Application Data
(60) Provisional application No. 63/758,466, filed on Feb. 14, 2025.

(51) Int. Cl. G09F 3/02; A01K 11/00

(52) U.S. Cl. CPC G09F 3/02; A01K 11/00; G09F 2003/0257

(57) ABSTRACT

An identification tag apparatus has a main frame with a flat body and at least one spherical insert member closely received within a respective insert bore extending through the main frame. One of the main frame and the insert member(s) is at least partly formed of magnetic material and the other is arranged to be magnetically attracted to the magnetic material such that the insert member(s) are balanced within the respective bores to protrude an equal distance from opposing side surfaces of the main frame. Optionally one or more secondary frames are mounted magnetically along the side surfaces of the main frame with respective apertures that also receive the insert member(s) extending therethrough. The magnetically retained insert members allow the user to customize the identification tag while securing multiple frame together in alignment.

### CROSS REFERENCE TO RELATED APPLICATION

This application claims the benefit under 35 U.S.C.119(e) of U.S. provisional application Serial No. 63/758,466, filed February 14, 2025.

### FIELD OF THE INVENTION

The present invention relates to an identification tag, for example a dog tag, of the type comprising a flat body of rigid material that can be mounted onto a chain to be worn about the neck of a user so that identifying inscriptions can be formed on the flat body for identification purposes and the like.

### BACKGROUND

Identification tags, such as military tags commonly known as dog tags, typically comprise a set of tags that can be mounted onto a neck chain worn about the neck of a user. The tags commonly impact one another with user movement resulting in undesirable noise.

It is also common to include various information inscribed or engraved on the rigid material of the tags for identification and/or decorative purposes. Such identifying tags are typically fixed in construction such that the decorative content cannot be changed once the tag has been formed.

### SUMMARY OF THE INVENTION

According to one aspect of the invention there is provided an identification tag apparatus comprising:

a main frame having a flat body at least partly formed of a frame material, the flat body including a first side surface and a second side surface defining a length and a width of the main frame, the length and the width being many times greater than a thickness of the flat body between the first side surface and the second side surface; and

at least one insert member received within a respective insert bore extending through the thickness of the main frame, the at least one insert member having a spherical body at least partly formed of an insert material, the spherical body having an outer diameter which corresponds approximately to an inner diameter of the respective insert bore and which is greater than the thickness of the main frame;

wherein one of the frame material and the insert material is magnetic and another one of the frame material and the insert material is ferromagnetic or magnetic;

whereby the at least one insert member is arranged to be retained within the respective insert bore in the main frame solely by magnetic attraction such that the at least one insert member is balanced within the respective insert bore to protrude an equal distance from each of the first side surface and the second side surface of the main frame.

The use of magnetically retained insert members in an identification tag allows the user to customize the tag in a simple manner using different colored or designed insert members that can be readily replaced while being securely held in place once mounted.

Optionally, one or two secondary frames may be mounted alongside the main frame. The secondary frames are also magnetically retained relative to the main frame by the magnetic compatibility between the frames are between the insert members and one or more frames. This prevents the multiple frames (or tags) from being displaced relative to one another so as to also eliminate any discomfort or noise associated with the tags impacting one another or otherwise being displaced relative to one another.

Preferably the secondary frame has a length and a width corresponding to the length and the width of the main frame.

Preferably a perimeter edge of the at least one secondary frame is aligned with a perimeter edge of the main frame about a full perimeter of the main frame in said mounted position, in which a thru bore in the main frame is aligned with a thru bore in the at least one secondary frame in the mounted position.

In preferred embodiments, the main frame is magnetic and the insert members are ferromagnetic to retain the insert members within the main frame. The secondary frame(s) may be ferromagnetic in this instance so that the main frame mounts both the insert members and the secondary frames thereon by magnetic attraction alone.

In other instances, the frames are ferromagnetic and the insert members are magnetic so as to retain the frames magnetically joined to one another. The insert members are partly received within corresponding recesses or bores in the secondary frame(s) when the frames are mounted alongside one another so that the insert members act to both align the frames and retain the frames firmly against one another by magnetic attraction alone.

In a preferred embodiment, the one or more secondary frames have a flat body which is arranged to be supported alongside one of the side surfaces of the main frame solely by said magnetic attraction, in which the at least one insert member is partly received within a respective secondary insert bore extending through said at least one secondary frame when the at least one second frame is supported alongside the main frame in a mounted position.

Preferably a diameter of the at least one insert member is greater than a combined thickness of the main frame and said at least one secondary frame. When there are two secondary frames, preferably a diameter of the at least one insert member is greater than a combined thickness of the main frame and the two secondary frames.

In some embodiments, the insert material may form a core of the insert member and the insert member further includes a secondary material which is non-magnetic (not magnetic and not ferromagnetic) surrounding the core.

One or both of the side surfaces of the main frame that receive a secondary frame mounted thereon may further include an auxiliary layer spanning the side surface in which the auxiliary layer is also non-magnetic. Preferably the auxiliary layer is a grip layer formed of resilient material having a high coefficient of friction mounted thereon so as to resist relative sliding between the main frame and said at least one secondary frame. When using two secondary frames, the grip layer preferably spans both of the side surfaces of the main frame.

In other embodiments of the secondary frames, the at least one insert member may be partly received within a respective insert recess formed in an inner side surface of said at least one secondary frame when the at least one second frame is supported alongside the main frame in a mounted position. The outer side surface of the at least one secondary frame opposite from the inner side surface is preferably continuous and uninterrupted at a location of the insert recess in this instance. Each insert recess may have a semi-spherical shape arranged to mate with a protruding portion of the respective insert member protruding from the corresponding side surface of the main frame.

Furthermore, each secondary frame of the type having an insert recess therein may further include a secondary bore extending through the secondary frame between the inner side surface and an opposing outer side surface and receiving a secondary member therein, in which the secondary member comprises a spherical body having an outer diameter which corresponds approximately to an inner diameter of the secondary bore within which the secondary member is received, the secondary member being magnetic or ferromagnetic so as to be arranged to be retained within the secondary bore solely by said magnetic attraction. In this instance, a secondary recess may be formed in the main frame in alignment with the secondary member of said at least one secondary frame, the secondary recess partly receiving the secondary member therein in the mounted position. The secondary recess of the secondary member of said at least one secondary frame is preferably shallower in depth than the insert recess in said at least one secondary frame of the at least one insert member. A thickness of said at least one secondary frame may be less than a radius of the secondary member. A combined measure of a depth of the secondary recess and a thickness of said at least one secondary frame may be approximately equal to a radius of the secondary member. The secondary frame(s) and the main frame may be formed of the same material, for example the secondary frame(s) and the main frame may be formed of the ferromagnetic material while the insert member is formed of the magnetic material.

### BRIEF DESCRIPTION OF THE DRAWINGS

Some embodiments of the invention will now be described in conjunction with the accompanying drawings in which:

FIG. 1 is an exploded perspective view of the identification tag apparatus according to the present invention;

FIG. 2 is a side elevational view of the identification tag apparatus according to FIG. 1 according to a first embodiment;

FIG. 3 is a side elevational view of the identification tag apparatus according to FIG. 1 in which one of the secondary frames has been removed;

FIG. 4 is a side elevational view of the identification tag apparatus according to FIG. 1 in which both of the secondary frames have been removed;

FIG. 5 is a sectional view along the line 5-5 in FIG. 2;

FIG. 6 is a sectional view along the line 6-6 in FIG. 2;

FIG. 7 is a sectional view along the line 7-7 in FIG. 4;

FIG. 8 is a side elevational view of the identification tag apparatus according to a second embodiment; and

FIG. 9 is a sectional view along the line 9-9 in FIG. 8.

In the drawings like characters of reference indicate corresponding parts in the different figures.

### DETAILED DESCRIPTION

Referring to the accompanying figures there is illustrated an identification tag apparatus generally indicated by reference numeral 10. The apparatus 10 is particularly suited for being suspended from a neck chain 12 of the type worn around the neck of a user.

Although various embodiments are shown in the accompanying figures, the features in common with the various embodiments will first be described.

The apparatus 10 in each instance generally includes a main frame 14 and a pair of secondary frames 16 arranged to be stacked on either side of the main frame to form a stack of frames which are held together by magnetic attraction as described in further detail below. Each frame comprises a flat, rigid body, for example a plate or sheet of rigid material such as metal and the like. Each of the frames 14 and 16 has a common length in a longitudinal direction between a first end 18 and a second end 20 of the frames, and a common width in a lateral direction, perpendicular to the longitudinal direction. The perimeter edges 22 of each of the frames is the same such that the perimeter edges are aligned with one another about a full perimeter thereof in the mounted position when the main frame 14 is stacked between the secondary frames 16.

The main frame 14 includes a first side surface 24 which is flat and planar against which a first one of the secondary frames 16 is abutted in the mounted position, and an opposing second side surface 26 which is similarly flat and planar against which a second one of the secondary frames 16 is abutted in the mounted position. The secondary frames 16 likewise each include an inner side surface 28 for abutment against the corresponding side surface of the main frame and an opposing outer side surface 30 which faces outwardly away from the main frame when the frames are stacked in the mounted position. Each of the frames has a thickness measured perpendicularly between the side surfaces of the frame. The frames 14 and 16 all have the same thickness in the preferred embodiment, such that the length and the width of each frame is many times greater than a thickness of the flat body of the frame between the first side surface and the second side surface of the frame.

Each of the frames 14 and 16 includes a through bore 32 extending fully through the frame in the direction of thickness between opposing side surfaces adjacent the first end 18 thereof. In the mounted position, the through bores 32 all align with one another to commonly receive the neck chain 12 or a removable mounting ring which in turn supports the frames on a neck chain in the mounted position.

The main frame further includes a plurality of insert bores 34 each receiving a respective insert member 36 mounted therein. In the illustrated embodiment, the insert bores 34 are arranged in a rectangular grid pattern comprised of three repeating rows of three bores per row. In further embodiments, the inset bores 34 may be evenly spaced apart from one another in a circumferential direction in a circular pattern. Alternatively, the number of bores within each row may vary to produce a diamond pattern or any other pattern of bores. The bores receive insert members 36 therein which are interlocked between the main frame 14 and the secondary frames 16 as described in further detail below. By providing two or more insert members 36 mounted within respective insert bores 34, the secondary frames are interlocked relative to the main frame to locate the secondary frames in both lateral and longitudinal directions and in angular orientation relative to the main frame to ensure the perimeter edges 22 are aligned with one another in the mounted position.

Each insert member 36 is a spherical body having an outer diameter which closely matches the inner diameter of the respective insert bore 34 within which the insert member is received. In practice, the outer diameter of the insert member is slightly undersized relative to the inner diameter of the bore to allow the insert member to be readily inserted and removed as described in further detail below. The insert member 36 is formed of an insert material which is compatible with the main frame material forming the main frame 14 such that the insert material and the main frame material are magnetically attracted to one another.

The outer diameter of each insert member is greater than the thickness of the main frame 14. The magnetic attraction between the insert member 36 and the main frame causes the insert member to be balanced and centred relative to the main frame in the direction of the thickness of the main frame. Due to the outer diameter of the insert member being larger than the thickness of the main frame, the insert member 36 protrudes by an equal protruding distance from each of the opposing side surfaces of the main frame in the mounted position. The insert member 36 is arranged to be held in the balance position in fixed relation to the main frame solely by the magnetic attraction between the insert member and the main frame. Each insert member 36 is readily removable by pushing the insert member through the bore with a force that exceeds the magnetic attraction.

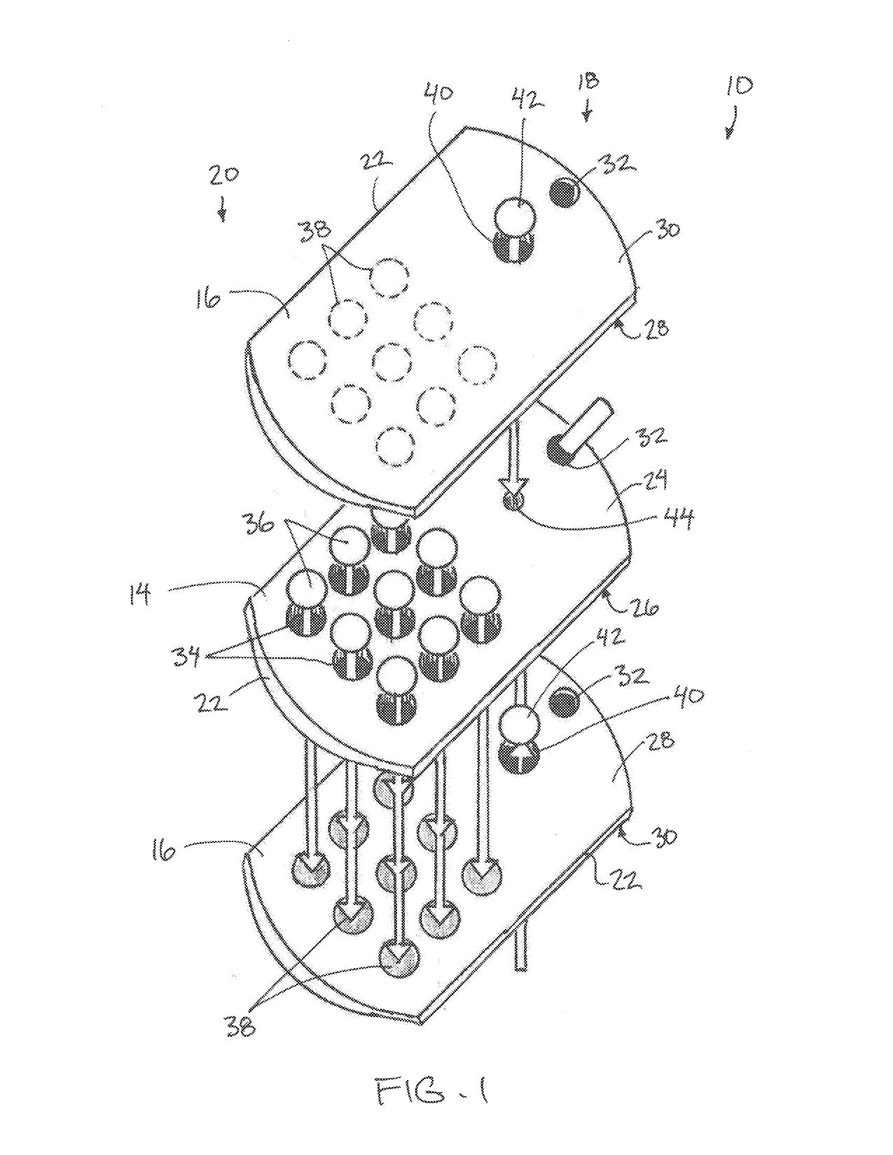

Turning now to the first embodiment shown in FIGS. 1 through 7, the insert members 36 in this instance are grouped together such that the group of insert members are nearer to the second end 20 of the frames opposite from the through bore 32 at the first end, while spanning a majority of the length to occupy a region between a longitudinal centre and the second end 20 of the main frame.

To accommodate the insert members 36 which protrude from either side surface, according to the first embodiment each secondary frame includes an insert recess 38 formed in the inner side surface 28 thereof so as to be in longitudinal and lateral alignment with a respective one of the insert members 36 in the mounted position of the frames. The insert recess 38 is semi-spherical in shape while having a depth and overall size that closely mates with the portion of the insert member 36 protruding from the corresponding side surface so that the insert recess 38 closely mates with the protruding portion of the insert member 36 received therein in the mounted position. The corresponding outer surface 30 of the secondary frames 16 is smooth, continuous and uninterrupted at the location of each insert recess 38.

Each secondary frame 16 also includes a secondary bore 40 formed therein at an intermediate location in the longitudinal direction between the through bore 32 and the grouping of insert members 36, while being centred in the widthwise or lateral direction. The secondary bore 40 extends perpendicularly through the secondary body to be penetrated fully through between the inner and outer side surfaces of the secondary frame 16. Each secondary bore 40 serves to support a corresponding secondary member 42 therein in which the secondary member 42 is a spherical body formed of the same material and having the same diameter as the insert members 36 described above. Again, the outer diameter of the secondary member 42 is approximately equal, while being slightly undersized, relative to the inner diameter of the secondary bore 40 within which it is received so as to permit the secondary member to be readily inserted and removed from the corresponding secondary bore. The outer diameter of the secondary member 42 is greater than the combined thickness of the main frame 14 and the secondary frame 16 within which it is received.

Each secondary member 42 supported within a respective secondary bore 40 in a respective secondary frame 16 is aligned with a corresponding secondary recess 44 formed in the corresponding side surface of the main frame 14 in the mounted position. The secondary recess 44 is semi-spherical in shape, having a depth and overall size which is smaller than the insert recesses 38. More particularly, a combined measurement of the depth of the secondary recess 44 together with the thickness of the secondary frame 16 is approximately equal to the radius of the secondary member 42. Accordingly, in the mounted position, when the secondary member 42 is fully nested into the secondary recess 44, the spherical body of the secondary member extends through the secondary bore in the secondary frame 16 so that approximately half of the diameter of the secondary member 42 protrudes outward from the outer side 30 of the stacked frames.

In a preferred arrangement, the spherical bodies of the insert members 36 and the secondary members 42 are formed of magnetic material while both the main frame 14 and the secondary frames 16 are formed of ferromagnetic material.

In other instances, only the main frame may be magnetic while all of the insert members 36, the secondary members 42, and the secondary frame 16 are formed of ferromagnetic material.

The frames 14 and 16 of the apparatus 10 can be used together in a stacked arrangement as shown in FIG. 2.

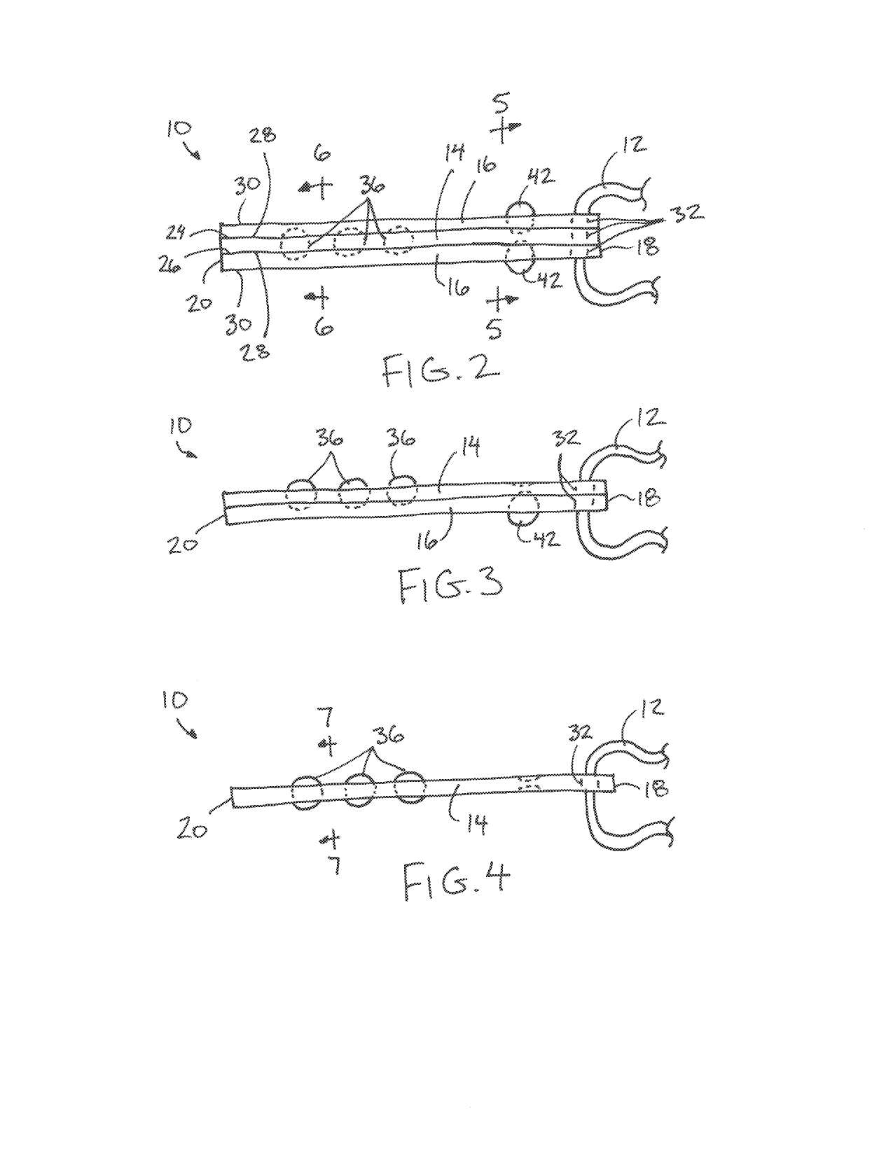

Alternatively, as shown in FIG. 3, one of the secondary frames 16 and the corresponding secondary member 42 supported therein may be removed to provide an arrangement where a single secondary frame and a single secondary member 42 received within that frame are supported alongside the main frame with the insert members 36 therein.

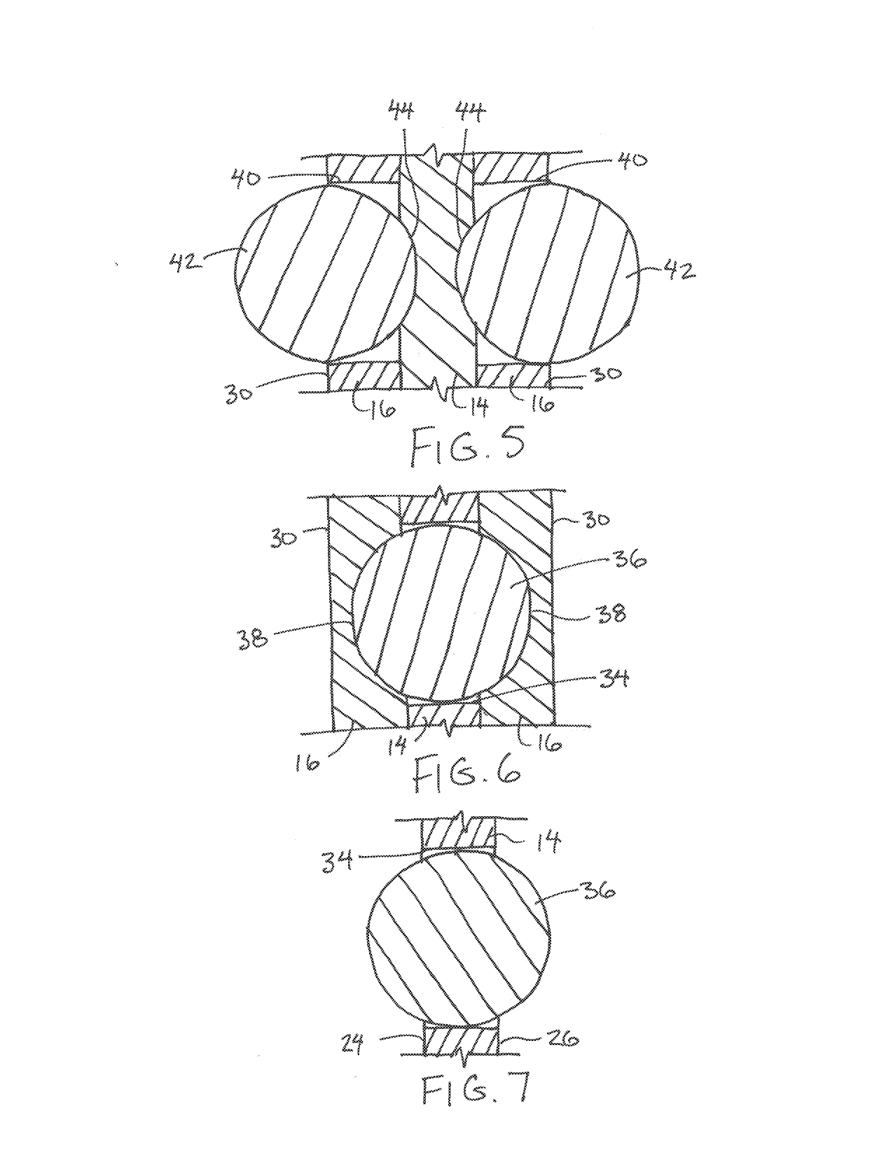

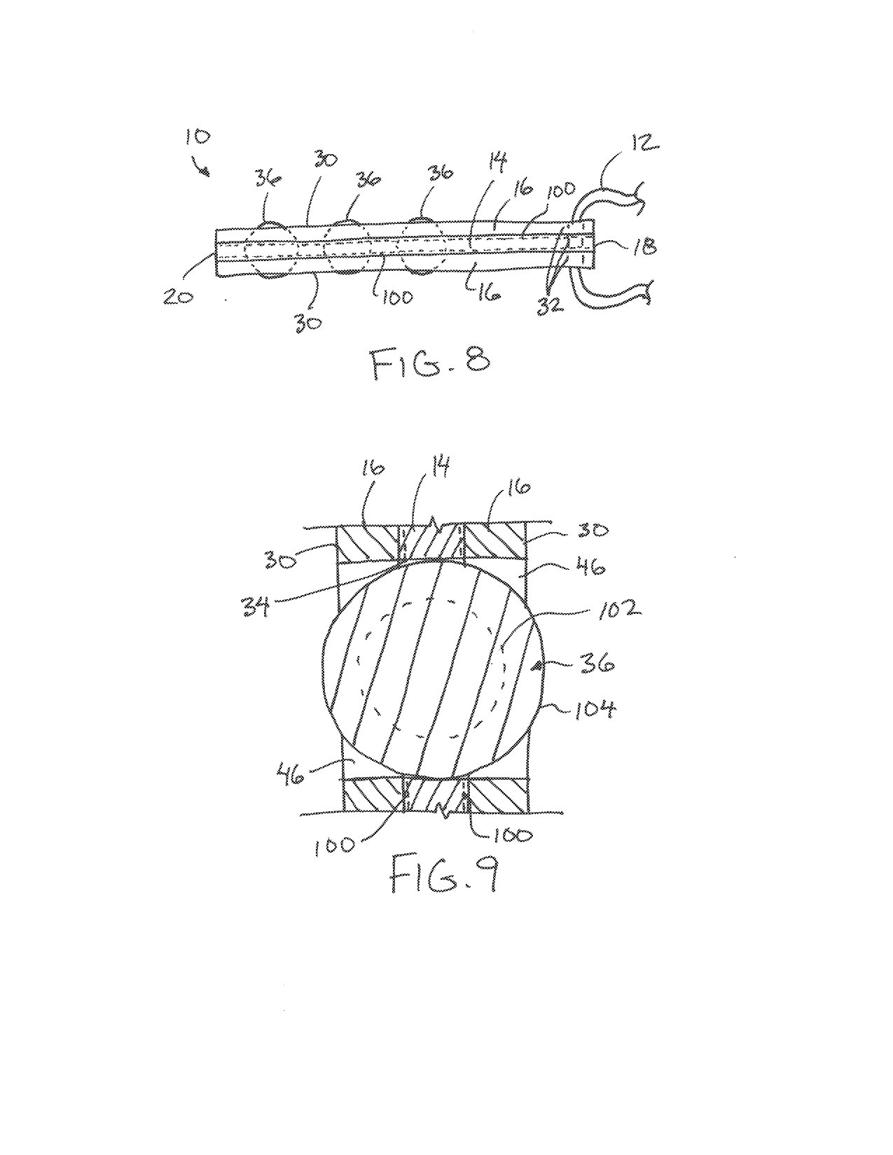

In yet a further optional arrangement, both secondary frames 16 can be removed with the secondary members 42 supported therein such that the main frame can support the insert members 36 therein without the secondary frames 16 as shown in FIG. 4.

In the illustrated embodiments, the plates have a thickness of approximately 2 mm while the bores have a diameter of approximately 5 mm. The spherical bodies defining the insert members 36 and the secondary members 42 in this instance have a diameter which is slightly undersized relative to the 5 mm bores so as to be between 4.8 and 4.9 mm for example.

In other embodiments, the insert members and the secondary members may have other diameters such as 2.5 mm or any other desired diameter. The dimensions of the corresponding bores remain closely matching the spherical bodies received therein.

Turning now to the second illustrated embodiment shown in FIGS. 8 and 9, the insert members 36 in this instance may have an outer diameter which is greater than the combined thickness of all three frames (14, 16 and 16). Accordingly in place of the insert recesses 38 formed in the secondary frames to receive part of each insert member 36 therein according to the previous embodiment, in the second embodiment each secondary frame is provided with a secondary insert bore 46 in longitudinal and lateral alignment with each insert member 36 supported within a respective insert bore in the main frame 14. The inner diameter of each secondary insert bore 46 is approximately equal to the inner diameter of the insert bore 34 in the main frame with which it is aligned. Each secondary insert bore 46 extends fully through the secondary frame between opposing side surfaces thereof in the direction of thickness of the secondary frame.

In the second embodiment, only the main frame 14 may be formed of magnetic material. The insert members 36 and the secondary frames are preferably formed of ferromagnetic material. The magnetic attraction alone of the secondary frames and the insert members relative to the magnetic material of the main frame is sufficient to maintain the frames stacked with one another in the mounted position while also supporting the insert members 36 in a balanced manner in the direction of thickness of the frames such that each insert member 36 protrudes by the same protruding distance from the outer sides of the secondary frames respectively as shown in FIG. 9.

The main frame 14 can be formed entirely of a frame material that is magnetic as a single unitary structure, or may be formed in layers including a core layer of magnetic material and additional layers of non-magnetic material such as a ceramic or resin coating layer for example. In the illustrated embodiment, both side surfaces of the main frame that receive respective ones of the secondary frames mounted thereon, further include a grip layer 100 formed of a resilient material that fully spans the side surface of the main frame. The grip layers 100 have a high coefficient of friction so as to resist relative sliding between the main frame 14 and the one or more secondary frames 16.

The insert member 36 may be formed entirely of an insert material that is ferromagnetic or may be formed as a composite. As shown in FIG. 9, the insert member may have a spherical core 102 formed of the insert material which is ferromagnetic or magnetic, and an outer shell 104 fully surrounding the spherical core which is formed of a secondary material that is non-magnetic such as a ceramic or resin coating layer formed about the core.

In an alternative arrangement, the outer diameter of the insert members 36 may be less than the combined thickness of the three frames. In this instance, the insert members remain balanced in the direction of thickness of the frames relative to the outer side surfaces such that the insert member is recessed by a similar recess depth relative to both of the two outer sides of the two secondary frames 16.

In all embodiments, the outer sides of the main frame 14 or the outer sides of one or both secondary frames can be used as a display surface upon which various information can be inscribed or printed. For example, the outer side surface of one of the secondary frames can be used for displaying content relating to a general theme whereas the outer side surface of the other secondary frame can be used for displaying content relating to a dedication.

Since various modifications can be made in the invention as herein above described, and many apparently widely different embodiments of same made, it is intended that all matter contained in the accompanying specification shall be interpreted as illustrative only and not in a limiting sense.

1. An identification tag apparatus comprising:
a main frame having a flat body at least partly formed of a frame material, the flat body including a first side surface and a second side surface defining a length and a width of the main frame, the length and the width being many times greater than a thickness of the flat body between the first side surface and the second side surface; and
at least one insert member received within a respective insert bore extending through the thickness of the main frame, the at least one insert member having a spherical body at least partly formed of an insert material, the spherical body having an outer diameter which corresponds approximately to an inner diameter of the respective insert bore and which is greater than the thickness of the main frame;
wherein one of the frame material and the insert material is magnetic and another one of the frame material and the insert material is ferromagnetic or magnetic;
whereby the at least one insert member is arranged to be retained within the respective insert bore in the main frame solely by magnetic attraction such that the at least one insert member is balanced within the respective insert bore to protrude an equal distance from each of the first side surface and the second side surface of the main frame.

2. The apparatus according to claim 1 wherein the frame material is magnetic.

3. The apparatus according to claim 2 wherein the insert material is ferromagnetic.

4. The apparatus according to claim 1 wherein said at least one insert member comprises a plurality of insert members, each received within a respective insert bore in the main frame.

5. The apparatus according to claim 1 comprising at least one secondary frame having a flat body which is ferromagnetic or magnetic so as to be arranged to be supported alongside one of the side surfaces of the main frame solely by said magnetic attraction, the at least one insert member being partly received within a respective secondary insert bore extending through said at least one secondary frame when the at least one second frame is supported alongside the main frame in a mounted position.

6. The apparatus according to claim 5 wherein said at least one secondary frame has a length and a width corresponding to the length and the width of the main frame.

7. The apparatus according to claim 5 wherein a perimeter edge of the at least one secondary frame is aligned with a perimeter edge of the main frame about a full perimeter of the main frame in said mounted position, and wherein a thru bore in the main frame is aligned with a thru bore in the at least one secondary frame in the mounted position.

8. The apparatus according to claim 5 wherein a diameter of the at least one insert member is greater than a combined thickness of the main frame and said at least one secondary frame.

9. The apparatus according to claim 5 wherein the at least one secondary frame comprises two secondary frames supported alongside respective ones of the side surface of the main frame, and wherein a diameter of the at least one insert member is greater than a combined thickness of the main frame and the two secondary frames.

10. The apparatus according to claim 5 wherein the main frame is formed of the magnetic material and the at least one secondary frame is formed of ferromagnetic material.

11. The apparatus according to claim 10 wherein the insert material is ferromagnetic.

12. The apparatus according to claim 5 wherein the insert material forms a core of the insert member, the insert member further comprising a secondary material which is non-magnetic surrounding the core.

13. The apparatus according to claim 5 wherein said one of the side surfaces of the main frame receiving said at least one secondary frame thereon further includes a grip layer formed of resilient material having a high coefficient of friction mounted thereon so as to resist relative sliding between the main frame and said at least one secondary frame.

14. The apparatus according to claim 13 wherein the at least one secondary frame comprises two secondary frames supported alongside respective ones of the side surface of the main frame, and wherein the grip layer spans both of the side surfaces of the main frame.

15. The apparatus according to claim 1 further comprising at least one secondary frame having a flat body which is magnetic or ferromagnetic so as to be arranged to be supported alongside one of the side surfaces of the main frame solely by said magnetic attraction, the at least one insert member being partly received within a respective insert recess formed in an inner side surface of said at least one secondary frame when the at least one second frame is supported alongside the main frame in a mounted position.

16. The apparatus according to claim 15 wherein an outer side surface of the at least one secondary frame opposite from the inner side surface is continuous and uninterrupted at a location of the insert recess.

17. The apparatus according to claim 15 wherein said insert recess has a semi-spherical shape arranged to mate with a protruding portion of the respective insert member protruding from the corresponding side surface of the main frame.

18. The apparatus according to claim 15 wherein said at least one secondary frame comprises two secondary frames supported alongside the first side surface and the second side surface of the main frame respectively.

19. The apparatus according to claim 15 wherein said at least one secondary frame includes a secondary bore extending through the secondary frame between the inner side surface and an opposing outer side surface and receiving a secondary member therein, the secondary member comprising a spherical body having an outer diameter which corresponds approximately to an inner diameter of the secondary bore within which the secondary member is received, the secondary member being magnetic or ferromagnetic so as to be arranged to be retained within the secondary bore solely by said magnetic attraction.

20. The apparatus according to claim 19 further comprising a secondary recess formed in the main frame in alignment with the secondary member of said at least one secondary frame, the secondary recess partly receiving the secondary member therein in the mounted position.
